(19) United States
(12) Patent Application Publication
(10) Pub. No.: US 2016/0277569 A1
(43) Pub. Date: Sep. 22, 2016

(54) SYSTEM AND METHOD FOR COORDINATING CALLS BETWEEN TWO OR MORE COMMUNICATION DEVICES

(71) Applicant: TSEMED PITRONOT LTD, Beit Shemesh (IL)

(72) Inventors: Jonathan Michael SHINE, London (GB); Andrew Goldman, Beit Shemesh (IL); Simon Shaw, Shoham (IL)

(21) Appl. No.: 15/070,075

(22) Filed: Mar. 15, 2016

Related U.S. Application Data
(60) Provisional application No. 62/133,547, filed on Mar. 16, 2015.

(51) Int. Cl. H04M 3/42; H04M 3/51

(52) U.S. Cl. CPC H04M 3/42365; H04M 3/5158

(57) ABSTRACT

A system and method for automatically establishing phone calls between parties are disclosed. The method comprising receiving indications of the availability status of the parties, receiving call request from at least one of the parties and establishing a call between parties when availability conditions are met.

### CROSS REFERENCE TO RELATED APPLICATIONS

This application claims the benefit of U.S. Provisional Patent Application No. 62/133,547, filed on Mar. 16, 2015 and entitled SYSTEM AND METHOD FOR COORDINATING CALLS BETWEEN TWO OR MORE COMMUNICATION DEVICES, which is incorporated herein by reference in its entirety.

### BACKGROUND OF THE INVENTION

In today's world, people are relying more and more on their smart phone as their main communication devices. The penetration of smart phones continues to grow, and it is estimated to be as high at 75% in the US market (Q1 2015). While people tend to use more and more applications that offer rich communication capabilities, such as Voice over IP (VoIP) calling, instant messages and presence information, the most basic, and yet widely used method of communication, is phone calling using the built-in native voice dialer, when one person simply calls someone and talk with him or her over the phone. This means of communication is widely used, for example, when at least one of the parties engaged in the phone call is busy doing something that prevents him/her from typing/clicking or otherwise operating smart capabilities of the smartphone. Such situation may be when at least one of the parties is busy driving a car. This basic and widely used capability has a major drawback—the caller does not know if the callee is available to take the call and, therefore, may be calling “blindly”, hoping that the callee will answer the call. The attempt to establish this call may fail due to one or more of the following reasons: the callee may already be engaged in another call, the callee may be in a location with no phone service coverage, the callee's device may be turned off, the callee may be in the process of establishing another call, or he/she may deliberately choose not to answer (ignoring the call deliberately). In some cases the false call may cause the callee to try calling the caller back when he/she becomes available but, in some cases this call back may fail if the caller is, eventually, unavailable. The percentage of incomplete calls is estimated to be as high as 50% and during peak busy hours may even get to 70%.

Another drawback of the fact that it is impossible to know the availability of the callee when a call center or a service provider it trying to reach a customer (the callee in this example). For example, a hospital calling patients to remind them of their upcoming appointments—many of these calls are not answered by the patients who are receiving the calls while they are unavailable (e.g., in meetings, or talking on the phone with others), resulting in a voicemail message that may or may not be picked up in time before the appointment. The inefficiency of this calling experience is often mitigated by adding a human coordinator (secretary) who is coordinating a convenient time for the caller and the callee, sometimes two secretaries will coordinate for their two managers.

### SUMMARY OF THE INVENTION

A method for automatically monitoring availability status of users and automatically issuing availability notifications or establishing calls between two or more parties based on the parties availability is disclosed, the method comprising providing availability status of a first party and of a second party to a central service, monitoring, by said central service, a request by said first party to establish a phone call with said second party, continuously monitoring the availability status of said second party to identify when said second party becomes available for a phone call and automatically issuing a notification to the first party of the availability of the second party or establishing a phone call between said first party and said second party.

According to some embodiments, the method further comprises, when said second party becomes available, establishing a phone call with said first party only if predefined call conditions of said first party and said second party are met.

According to some embodiments, the predefined call conditions of the first and/or the second party is at least one from the list comprising time in the day, geographic location, type of activity of said first and/or the second party.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram of a system for providing availability dependent connectivity between users according to some embodiments of the present invention;

FIG. 2 is a flow diagram of user registration functionality, according to some embodiments of the present invention;

FIG. 3 is a flow diagram of manual change of user's status functionality, according to some embodiments of the present invention;

FIG. 4 is a flow diagram of automatic change of user's status functionality when the user is engaged in a call, according to some embodiments of the present invention;

FIGS. 5A and 5B are flow diagrams of automated group calls management functionality when the users in the group are registered and connected, according to some embodiments of the present invention;

FIGS. 5C and 5D are diagrams of automated group calls management functionality when some of the users in the group are not registered users, according to some embodiments of the present invention;

FIGS. 5E and 5F are diagrams of automated group calls management functionality when some of the registered users in the group are busy throughout the entire call session, according to some embodiments of the present invention;

FIG. 6 is a flow diagram of automated group calls management functionality when the users in the group are registered and connected, but at least one group member is not available, according to some embodiments of the present invention;

FIG. 7 is a flow diagram of automated issuance of notification of a change of status of a user when he/she becomes available, according to some embodiments of the present invention;

FIG. 8 is a flow diagram of automated call initiation based on predefined conditions, according to some embodiments of the present invention;

FIG. 9 is a flow diagram of issuance of a request from a remote user to call when predefined conditions are met, according to some embodiments of the present invention;

FIGS. 10A and 10B are flow diagrams of issuance of a request from a user to he called by an agent of a company or a call center service, according to some embodiments of the present invention; and

FIGS. 11A, 11B and 11C are flow diagrams of automated call establishment between two parties based on common features defined by the parties, according to some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

System operating according to some embodiments of the present invention may include a controller and at least one memory unit. A controller may be, for example, a central processing unit processor (CPU), a microcontroller, and a chip comprising any suitable computing or computational device. A memory unit may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable non-transitory memory units or storage units. A memory unit may be or may include a plurality of possibly different memory units.

Some embodiments of the present invention may comprise software programs comprising executable code such as an application, a program, a process, task or script. Such executable code may be executed by a controller, possibly under control of an operating system. For example, a controller included in a system embodying some embodiments of the present invention may execute an executable code which may cause the controller to perform operations described herein below.

A system according to some embodiments of the present invention may include a storage device which may be, or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in such storage and may be loaded from the storage into a memory unit where it may be processed by a controller. In some embodiments, some of the components may be omitted. For example, a memory unit may be a non-volatile memory having the storage capacity of a storage unit. Accordingly, although memory unit(s) and storage unit(s) may be shown as separate components, a storage unit may be embedded or included in memory unit.

A system according to some embodiments of the present invention may include one or more input devices which may be or may include a mouse, a keyboard, a touch screen or pad or any suitable input device. It will be recognized that any suitable number of input devices may be operatively connected to a controller according to some embodiments of the present invention. A system according to some embodiments of the present invention may include one or more input devices output devices which may include one or more displays, speakers and/or any other suitable output devices. For example, screenshots or images of a display may he screenshots or images of a display screen attached to a controller. It will be recognized that any suitable number of output devices may he operatively connected to a controller according to some embodiments of the present invention.

Some embodiments of the present invention may include an article such as a computer or processor's non-transitory readable medium, or a computer or processor's non-transitory storage medium, such as for example a memory, a disk drive, or a USB flash memory. The non-transitory storage medium may be, or may include or store instructions, e.g., computer-excutable instructions, which, when executed by a processor or a controller, carry out methods disclosed herein.

A user who wishes to make a phone call to one or more remote users may encounter difficulties in completing the call for one or more reasons, such as the remote user is busy, the remote user's phone device is disabled/shut down/out of service range, and the like. Many times reiterating the phone dialing is an undesired burden and in some cases it may pose a risk, for example when the calling party is driving a car.

There is a need for system and method that will enable a user, also denoted calling party, to set a wish list of remote users to whom he/she wishes to make phone calls and, preferably, to adjust priority to these calls and let the system automatically look for the available users and establish a phone call only when the remote user(s) is/are available to take a call. The establishing of such phone calls should preferably be indifferent to the identity of the phone service provider of the called user(s) (also denoted callees). The establishing of such phone calls may obey a priority list set by the user. Availability of a callee may be defined based on one or more status flags of the callee, such as communication availability (the callee's phone is available and the callee is not engaged in another call) and definition of the callee as to calls he/she allow to accept (for example calling parties he/she allows to connect and calling parties he/she refuses to connect).

In order to enable any user who completed registration process to a service according to the present invention to call any other such user based on availability of callees, all registered users need to provide their availability status to a centralized service that may be operated on a central server. The phone device of such user should be adapted to provide status signaling to the central server and further should be adapted to establish a phone call with the designated calllee(s) once call schedule plan conditions and availability conditions of the callee(s) are met, as will be explained in details below. Examples of availability status indications may comprise “User Available” which may be set manually by the user; “User Busy” which may he set manually by the user; “User In a Call” which may be set automatically by the service and “User Is Away” which may he set automatically if, for example, a predefined number of unique calls to that user are not answered within a predefined period of time. According to some embodiments of the present invention, a user's status “in a call” may be received by the system from other applications executed by the user's phone device, that are used for performing voice calls, chats or other kinds of communication between persons. Such indication may be relied upon by the system in order to prevent initiating calls by the system of the invention when a respective user is in a call performed by non-native applications.

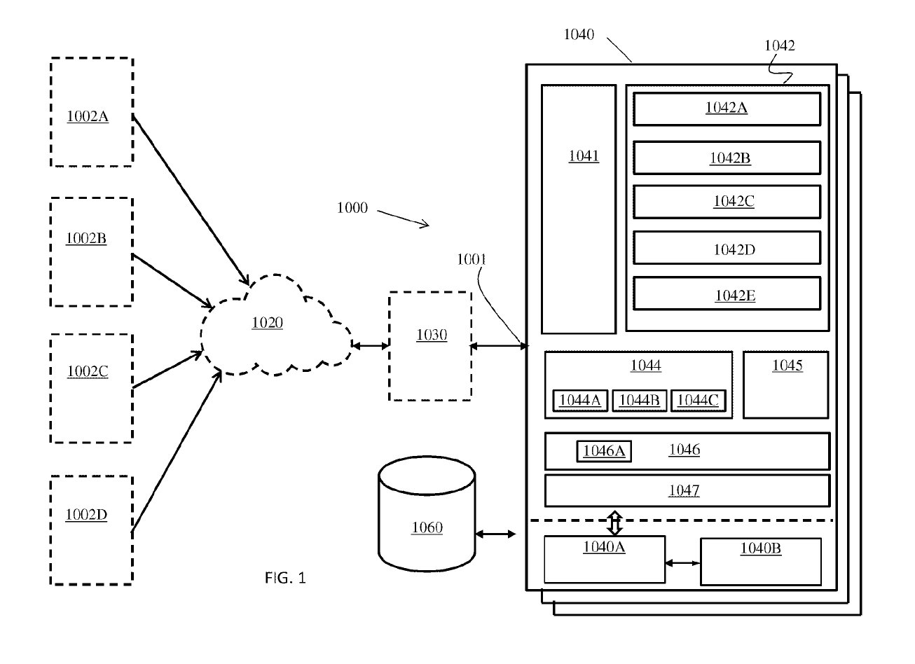

Reference is made now to FIG. 1 which is a schematic block diagram of system 1000 for providing availability dependent connectivity between users according to some embodiments of the present invention. System 1000 may be embodied in one or more hardware units and, in some embodiments, in one or more software units operable on one or more computing units, such as computing unit 1040A. System 1000 may comprise one or more memory units, such as memory unit 1040B, which are in operational communication with computing unit 1040A and are adapted to store programs, software packages and data that when executed perform the functionalities of system 1000, as described herein below. It will be apparent to those skilled in the art that the functionalities of system 10(X) described herein below define the operations and interrelations between same, yet their embodiments are not limited to specific hardware or to specific software units and may, in some embodiments, he embodied by combinations of software and hardware units. System 1000 may be in communication with one or more cellular telephone units 1002A, 1002B, 1002C and 1002D via network 1020 such as the Internet and optionally via signal handling facility 1030 which may include, or perform the function of one or more from a list comprising load balancing, firewall and Session Border Controller (SBC) unit. The signals entering system 1000 at input terminal 1001 or are sent via terminal 1001 represent. System 1000 may comprise application server functionality unit 1040 and database storage unit 1060.

Application server functionality unit 1040 may comprise Representational State Transfer (REST) architecture type APIs unit 1041, business logic unit 1042, push manager service unit 1044, SMS manager unit 1045, asynchronous task manager unit 1046 and Data Access Layer (DAL) unit 1047. Business logic unit 1042 may comprise registrar of subscribers unit 1042A, authentication unit 1042B, subscriber manager unit 1042C, group manager unit 1042D and call notifier unit 1042E. Push manager service unit 1044 may comprise Google Cloud Messaging (GCM) unit 1044A, Apple Push Notification System (APNS) unit 1044B and Microsoft Push Notification System (MPNS) unit 1044C. Asynchronous task manager unit 1046 may comprise call matcher unit 1046A to periodically examine a database of calls requests and identify whether call requirements (such as availability, location, status) have been met and can now be triggered.

Database storage unit 1060 may be in operative communication with server functionality unit 1040 for storing and fetching/retrieving of data. The data stored may be modeled in means other than the tabular relations used in relational databases for simplicity of design, horizontal scaling, and finer control over availability.

A system according to some embodiments of the present invention, such as system 1000 of FIG. 1, is capable of simplifying the scheduling of ad-hoc calls between people who have a busy schedule and businesses by replacing the task typically implemented by the caller or by a personal assistant. Such system also facilitates connecting people within or across communities who are in the mood for a phone call, as will be described in details herein below.

Various capabilities of a system operating according to some embodiments of the present invention will be presented herein below in the form of flow of operations between respective functionalities of the system.

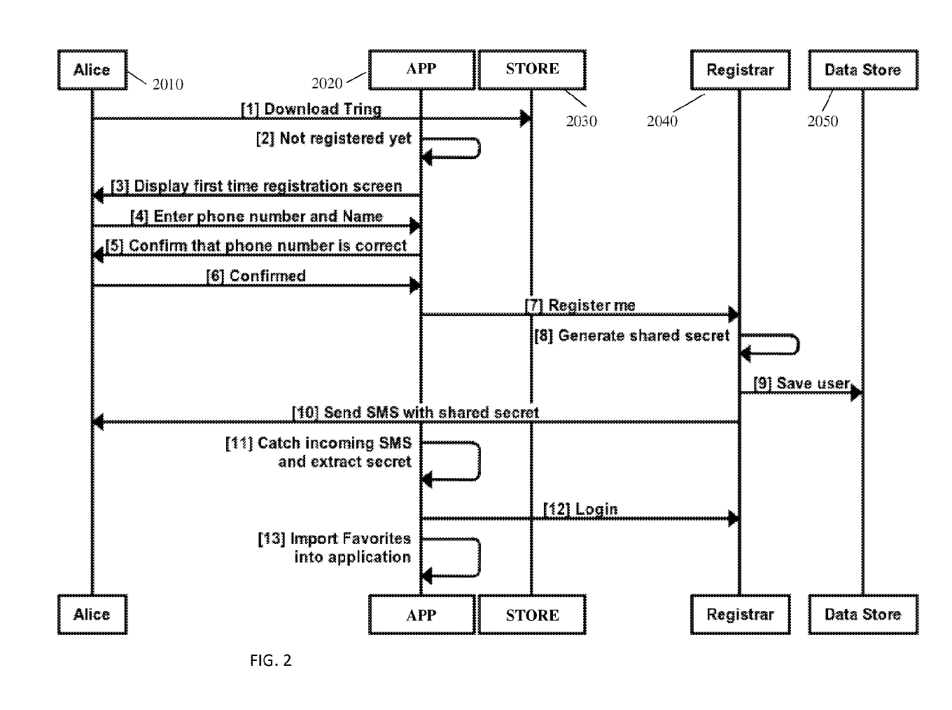

User Registration: in order for a user to be able to enjoy the advantages of solutions according to some embodiments of the present invention, a one-time registration should be performed. Reference is made now to FIG. 2, which is a flow diagram of user registration functionality, according to some embodiments of the present invention. User 2010 (denoted here “Alice”) connects a dedicated application store 2030, such as Google Play, and downloads and installs a client application on his/her telephone device, such as device 1002A-1002D (FIG. 1) [step 1]. Once the client side application has been installed, first—time registration steps are performed [steps 2-11] between user 2010 and its client application 2020, registrar functionality 2040 and data store functionality 2050, comprising user authentication measures and safety tools [steps 8-11]. At the end of the registration, functionality user 2010 details are saved in registrar functionality 2040 and in data store functionality 2050, user 2010 login data is stored in registrar 2040 [step 12] and client application 2020 of user 2010 is capable of importing favorites data [step 13]. Successful completion of this operation turns user 2010 (“Alice”) into a registered user with a system according to some embodiments of the present invention. At least two users need to be registered in order to enjoy the advantages of some embodiments of the present invention.

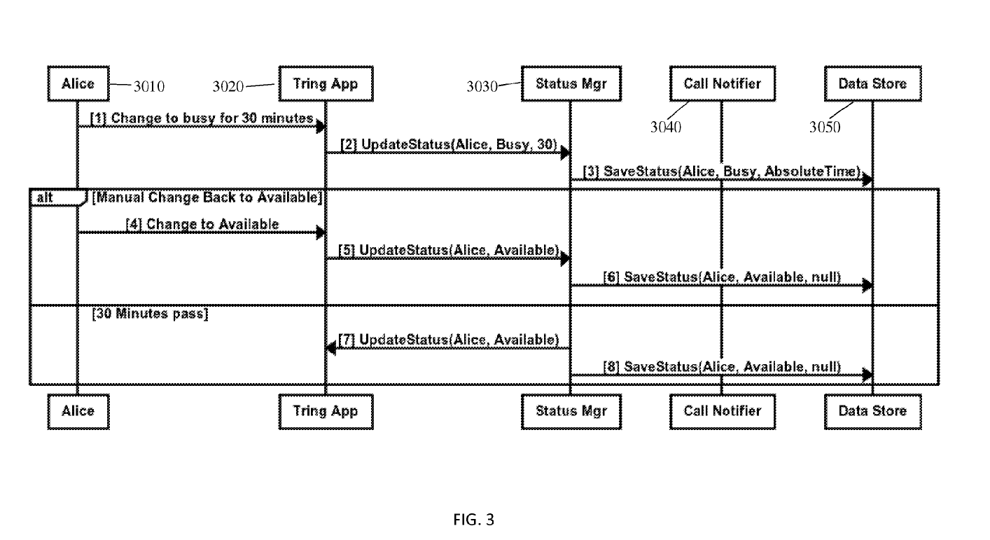

Manual Status Update: a registered user may manually change his/her status with the system. Reference is made to FIG. 3, which is a flow diagram of manual change of user's status functionality, according to sonic embodiments of the present invention. Registered user 3010 (denoted “Alice”) initiates a manual status change, for example notify the system status manager functionality 3030 that it is “busy” [steps 1, 2] via client application 3020. Status manager functionality may update this change of status in data store functionality 3050 [step 3]. As may be seen in steps 4-6, manual reversal of the availability status of user 3010 may be performed in a similar manner and the change is eventually registered in data store functionality 3050. In cases where the “busy” status change was manually initiated for a predefined period of time, when this period of time lapses the availability status of user 3010 is automatically changed by status manager 3030 and the change is registered both at the client's application 3020 and data store functionality 3050 [steps 7, 8].

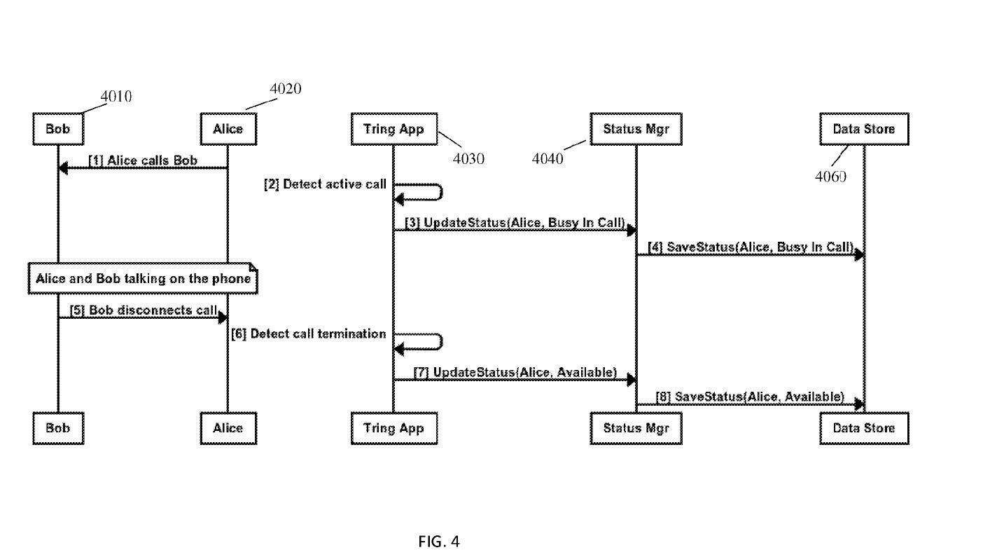

In a Call Status Update: the availability status of a registered user may automatically change whilst being engaged in a call. Reference is made to FIG. 4, which is a flow diagram of an automated change of user's status functionality when the user is engaged in a call, according to some embodiments of the present invention. A first user 4010 (denoted “Bob”) is called by a second, registered user 4020 (denoted “Alice”), and a call between them is established [step 1]. Client's application 4030 of user 4020 detects that user 4020 is engaged in a call [step 2] and automatically changes its status with the system by updating status manager functionality 4040 [step 3] and saving the change with data store functionality 4060 [step 4]. Once the call terminates, for example due to disconnection by one of the parties, e.g., user 4010 (“Bob”) [step 5] user 4020 client application 4030 detects this call termination [step 6] and may automatically update status manager functionality 4040 [step 7] and save the change of status with data store functionality 4060 [step 8].

According to some embodiments of the present invention, the system may provide notification to registered users reflecting change in the availability status of other registered users. For example, if a first registered user expressed interest in the availability of another registered user, for example by trying to call that other user, or initiating a call request via the system, or by including that user in a call group, etc., and the call could not be carried out right away, for example because the other user was “busy”, “unavailable” or otherwise not in a status to enable establishing a call with the first user, the system may issue a notification to the first user when the second user has become available. Such notification will allow the first user to decide whether he/she still wants to establish the call or just give it up. The availability may reflect manual change of the status, begin/end of a call, use of a dialer, time of the day, geographical location and activity.

In order to efficiently monitor the availability status of a user, the system may notify the client's application of relevant devices that it should periodically send a status indication (for example, every 10 minutes) for a predefined period of time (for example, for 60 minutes) or immediately issue a status change indication when this change was detected at the client's application of that device. A device may be considered relevant if another user has expressed interest in its status either by creating a call request on the user, activating the ‘notify me’ feature or by viewing/calling a group where the device is included. If, after the predefined period of time, there are still callers that are interested in the status of the particular (i.e., relevant) device, the server may again notify the client's application of the monitored device to periodically update for a further predefined period of time. If the system detects that the requested call was not successfully completed (e.g., short call, busy call etc.), it may ask the calling user if he/she wants to be notified when the callee next becomes available or alternatively add the callee to a group.

According to some embodiments, if a registered user activates a ‘Notify Me’ function, when a monitored user becomes available, its application will send an update to the system and the system will send a time limited message to the user that has requested to be notified. This message will remain valid in the notification system of the client's application for a predefined time or until that user handles the notification.

According to some additional embodiments, a first user may define, in a “Notify Me” function, that the system will notify the first registered user that one or more certain conditions defining the status of a second registered user were met, in order to allow the first user to establish a call with the second user. Such status conditions may reflect the availability of the user, the geographic location of the user, the activity of the user (for example, ‘in a ride’ based on for example GPS readings, or in a meeting' based on calendar application's data, etc.) It should be readily understood by those skilled in the art that indications of activity of a user may be received from additional data sources, such as wearable devices (e.g., wearable watch and the like), as known in the art. Such wearable device may be in operative communication with the phone device of the user and may provide activity indications and information via dedicated applications executed on the user's phone device.

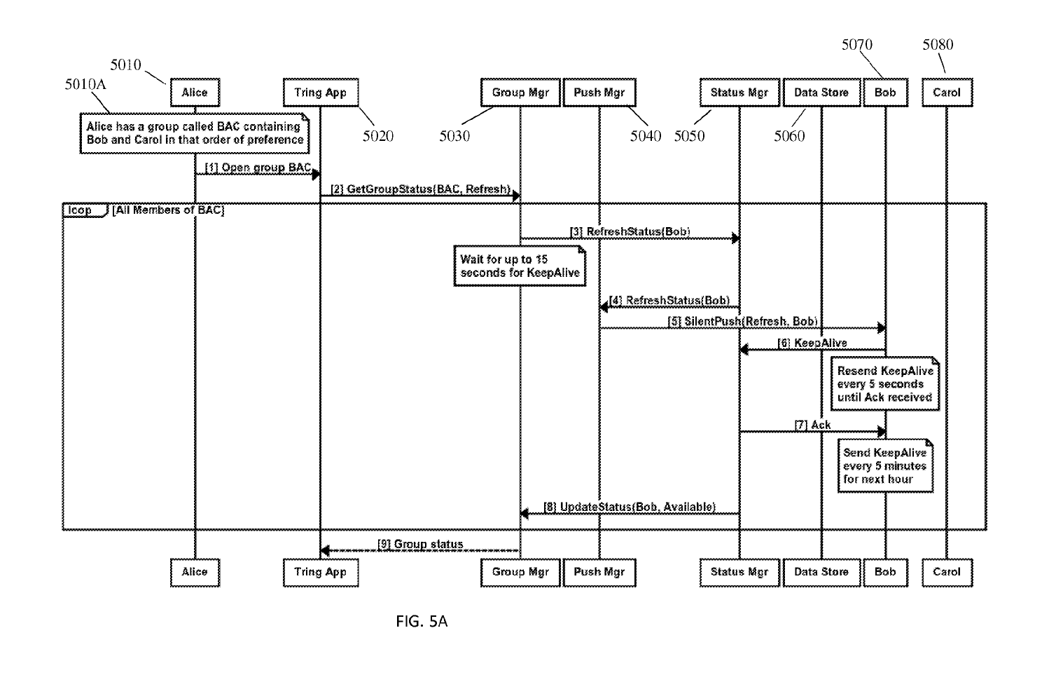

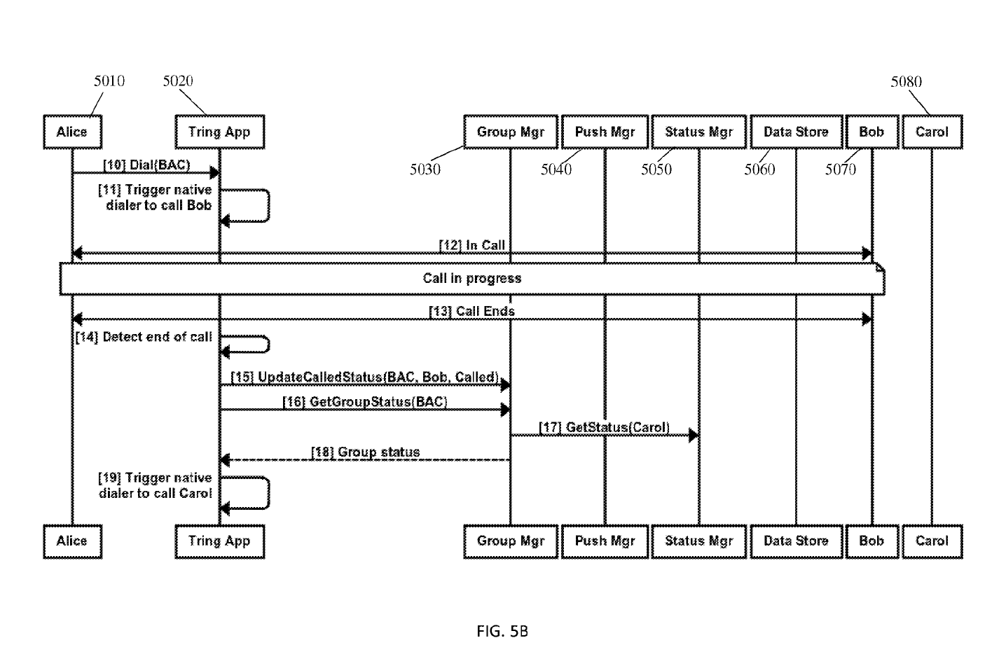

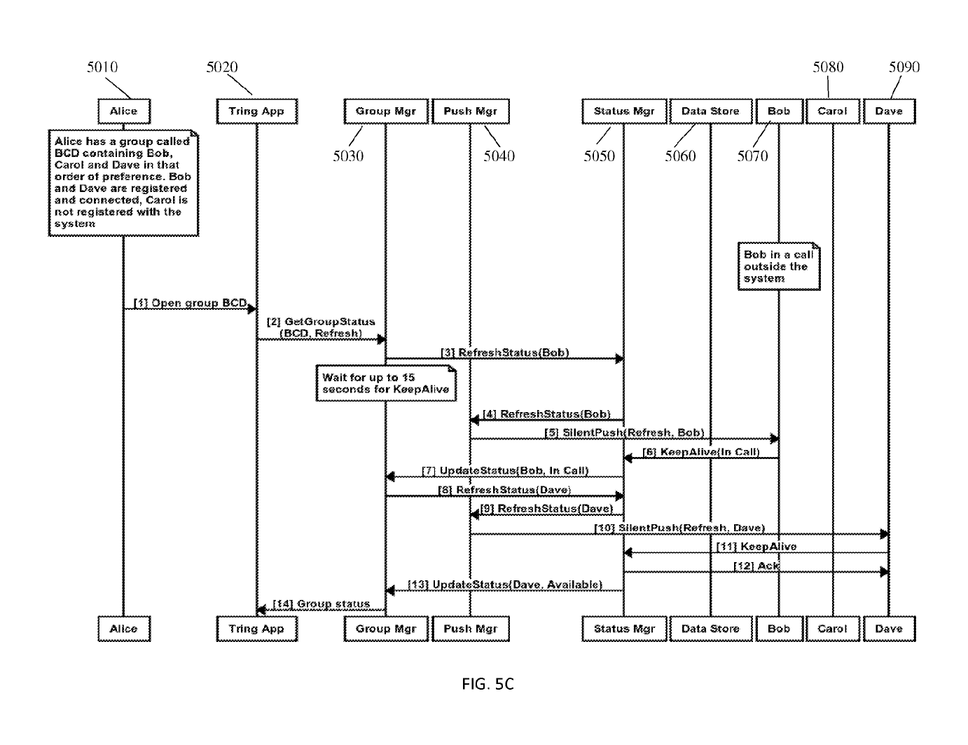

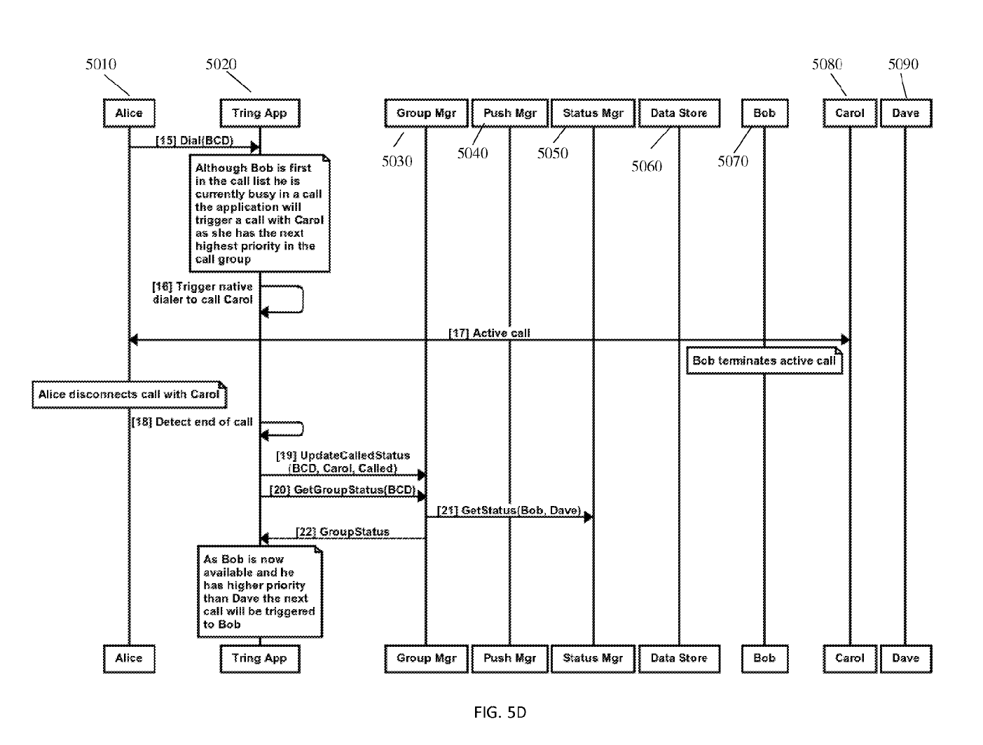

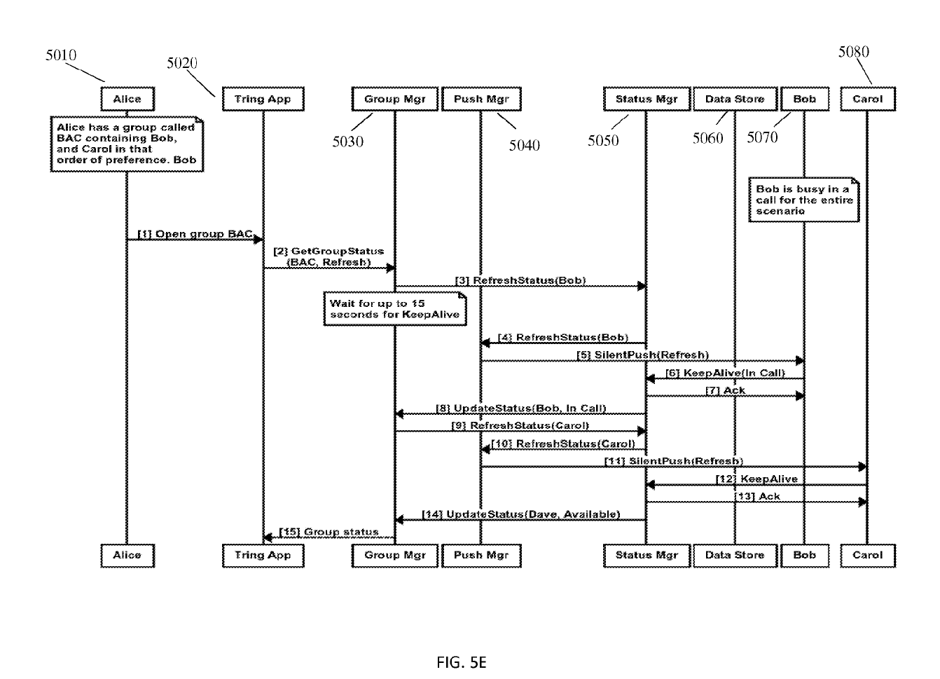

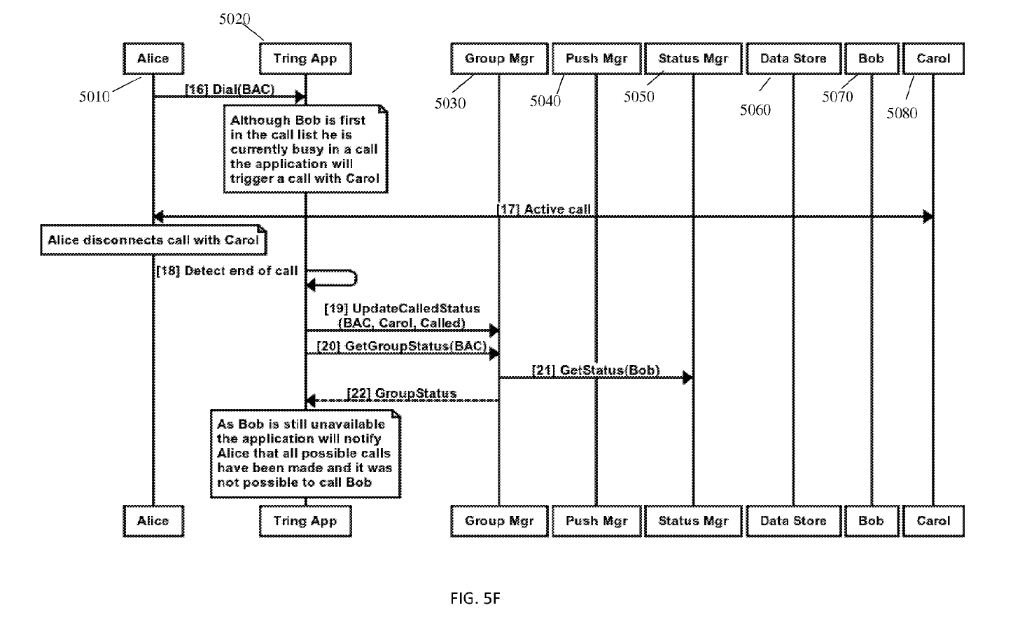

Call Group of Registered and Connected Users: two or more registered users may be formed in a group, defined by one of these users. The definition may assist in defining automated call scheduling to that group of users. Reference is made to FIGS. 5A and 5B, which are flow diagrams of automated group calls management functionality when the users in the group are registered and connected, according to some embodiments of the present invention. A registered user 5010 (denoted “Alice”) may establish a users' group 5010A that may comprise additional registered users 5070 and 5080, respectively (denoted here “Bob” and “Carol”) [step 1]. User's client application 5020 may be adapted to continuously receive indications of the availability of members in group 5010A from group manager functionality 5030 [step 2]. Continuous monitoring and updating of the availability of each of group 5010A members may be performed as follows, presented with respect to group member 5070 (Bob). Group manager functionality 5030 may be adapted to periodically initiate status query as to the status of user 5070 by sending the query to status manager 5050 [step 3]. Status manager functionality 5050 may respond [step 4] thus notifying push manager functionality 5040 that the availability of user 5070 is explored. Push manager functionality 5050 initiates a scheme of interrogation of the availability of user 5070 (denoted “KeepAlive”) that takes place according to definable schedule of time of sending status interrogation request and waiting for a response, between status manager functionality 5050 and the client application of user 5070 [steps 6, 7] until the client application of user 5070 responds to group manager functionality 5040 by providing the availability status of user 5070 [step 8] which is, in the example of FIG. 5A “available”. In a similar manner, the availability of other users, such as user 5080, is delivered to group manager functionality 5040. At the end of the status interrogation cycle, the status of all members of group 5010A is provided by group manager functionality 5040 to client application 5020 of user 5010 [step 9].

Once status of members of group 5010A is detected a call may be initiated by client application 5020 of user 5010, to first member of group 5010A, for example user 5070 [step 10]. This step initiates a dial from user 5010 to user 5070 [step 11] using dialing functionalities of the respective parties (native dialing), e.g., dialing the phone number of user 5070 by a dialer of user 5010. It will be appreciated by those skilled in the art that, according to some embodiments of the present invention, the ability to establish a phone call using the native dialer of the user is novel and non-obvious, since the client application portion of the system that is installed and executed on the user's smart phone enables not only reflection of the availability status of the user, including whether the user is dialing or not, but also using its native dialer to establish a call. According to some embodiments of the present invention, for registered users the indication of a “Busy in a call status” will be signaled when the dial button was pressed at the caller's side and when the phone starts ringing at the callee's side. Step 12, “in call”, indicates that a call session is established between user 5010 and user 5070. Step 13, “call ended”, indicates that the call session between user 5010 and user 5070 ended. The change in status of user 5010 is detected and registered by client application 5020 [step 14]. Additionally the list of calls to be carried out, as defined by user 5010 is updated indicating that the call to user 5070 has been carried out [step 15]. Client application 5020 may now examine the possibility of carrying out the next call on the to-be carried out calls defined by user 5010. Assuming that the next call is to he made between user 5010 and user 5080, a request to update the availability status of group 5010A is sent by client application 5020 to group manager functionality 5030 [step 16]. Group manager functionality 5030 initiates status interrogation with status manager functionality 5050 [step 17]. Once user 5080 is available, the availability of user 5080 is acknowledged, and this indication is immediately delivered to client application 5020 of user 5010 [step 18], which in turn triggers a native dialer of user 5010 to dial the number of user 5080 [step 19].

According to some embodiments, a system operating according to the present invention may service registered users who form a call group that includes also unregistered users. Reference is made to FIGS. 5C and 5D, which are diagrams of automated group calls management functionality when some of the users in the group are not registered users, according to some embodiments of the present invention. Similarly to the diagram of FIGS. 5A and 5B a registered user 5010 (denoted “Alice”) may establish a call group 5010A that may comprise additional users: user 5070 (“Bob”) and user 5090 (“Dave”) who are registered users, and user 5080 (“Carol”) who is not a registered user. The call preferred order is user 5070, then user 5080 and then user 5090 [step 1]. In order to establish a call to user 5070 and keep an updated status of registered users 5070 and 5090, steps 2 to 15 are performed in a corresponding manner to steps 2 to 9 of FIGS. 5A and 5B, with the difference here that user 5070 is busy through these steps. Accordingly, the group call manager initiates a call to the next user on the call group, user 5080. Since user 5080 is not a registered user, the call is initiated without further status investigations (‘blind call’) using the native dialer of user 5010 [step 16]. When the call between user 5010 and user 5080 terminates [step 17], and the end of call is detected [step 18], the system updates the open items on the call list [step 19] and updates the availability status of registered users 5070 and 5090 [steps 20, 21]. User 5070, who was busy during previous stages, is now detected to be available according to this example [step 22], and accordingly the system may tend to establish a call from user 5010 to user 5070 and proceed according to the preferences dictated in the group

A private case of the example described above with respect to FIGS. 5C and 5D is the case when at least one of the registered users is busy through the entire session related to performing of the jobs in a group call defined by one registered user. For example, the busy registered user is busy through the entire travel of the calling user. Reference is made to FIGS. 5E and 5F, which are diagrams of automated group calls management functionality when some of the registered users in the group are busy throughout the entire call session, according to some embodiments of the present invention. Similarly to the diagram of FIGS. 5A and 5B, registered user 5010 (denoted “Alice”) may establish a call group 5010A that may comprise additional registered users 5070 users (“Bob”) and 5080 (“Carol”). Steps 1 to 15 are performed similarly to the respective steps in FIGS. 5A and 5B, with the required changes, to define a call group comprising users 5070 and 5080 and to get continuously updating availability status of these users. Assuming that user 5070, the first user on the call list, is busy throughout the entire process described with respect to FIGS. 5E and 5F, in step 16 the system finishes the predefined number of status check rounds of user 5070 and switches to the next user on the list, user 5080. Accordingly, a call is established between user 5010 and 5080 [step 17], and when it terminates [step 18], the system repeats checking on the availability status of user 5070 [steps 19-22]. Since user 5070 remains busy, the call to user 5070 remains an open item on the call list.

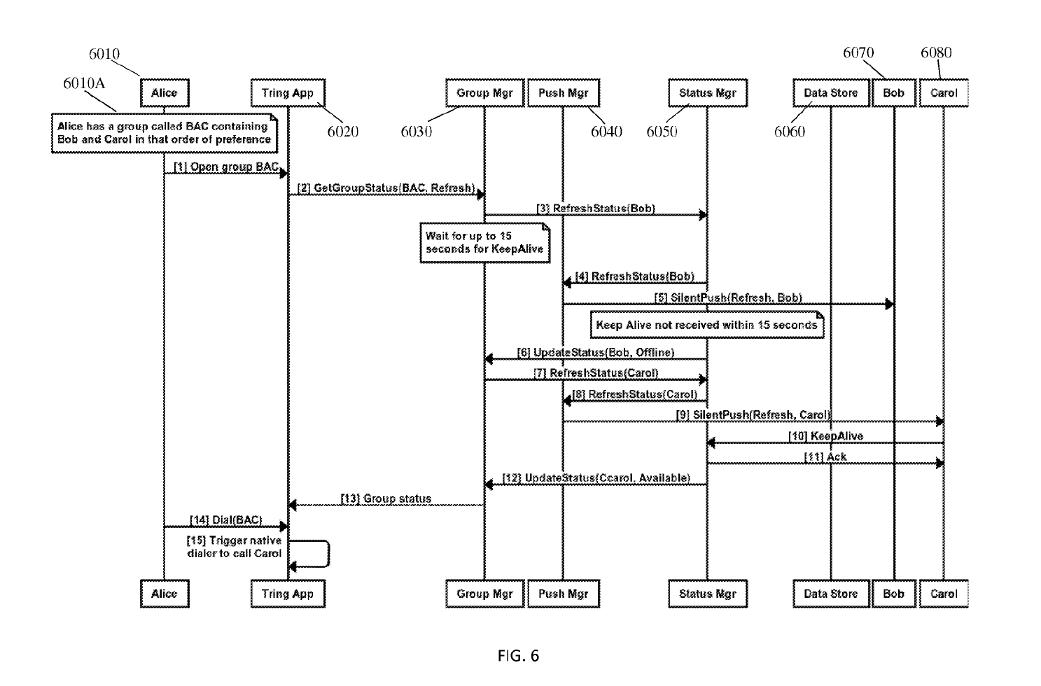

Managing a Group Call when one Group Member is not available: situation in which at least one group member in a group defined by a registered user is not available for establishing a call with him/her. Reference is made to FIG. 6, which is a flow diagram of automated group calls management functionality when the users in the group are registered and connected but at least one group member is not available, according to some embodiments of the present invention. User 6010 (denoted “Alice”) established a user group 6010A, which defines a list of users with which user 6010 wishes to automatically establish phone calls. Users group 6010A may include multiple members and, in the example of FIG. 6, at least user 6070 (denoted “Bob”) and user 6080 (denoted “Carol”). Steps 1 to 6 of FIG. 6 may be performed similarly to steps 1-8 of FIG. 5A, with respect to the interrogation of the status of user 6070. However, in the case of FIG. 6, the interrogation yields that user 6070 is not available (“offline”) [step 6]. In response to the received status of user 6070 (“offline”) an interrogation process of the availability status of user 6080 commences [steps 7-13 of FIG. 6] similarly to steps 3-8 of FIG. 5A. The interrogation yields that user 6080 is available, and this is indicated by group manager functionality 6030 to client application 6020 of user 6010 [step 13] which in turn initiates a native dial of user 6010 to user 6080 [steps 14, 15].

According to some embodiments, a registered user, or a delegated person on his/her behalf, may be able to configure, via for example a web application of the system, at least one configurable feature of the user, at any desired time in real time including, but not limited to, add/remove/update member to a call group, create/delete a call group, change order of members in a call group and set privacy policy. A change in the configuration of a feature of a registered user that was entered via a web application will appear in the user's client application on his/her phone device following the completion of the change in the web application. Login to the web application may make use of the same user's account on the device (account must first be created on the device). In order to control access to the user's web account, the user may be able to set a web password from the application on his/her device. According to some embodiments, the user name may be the full E164 number of the user's phone device.

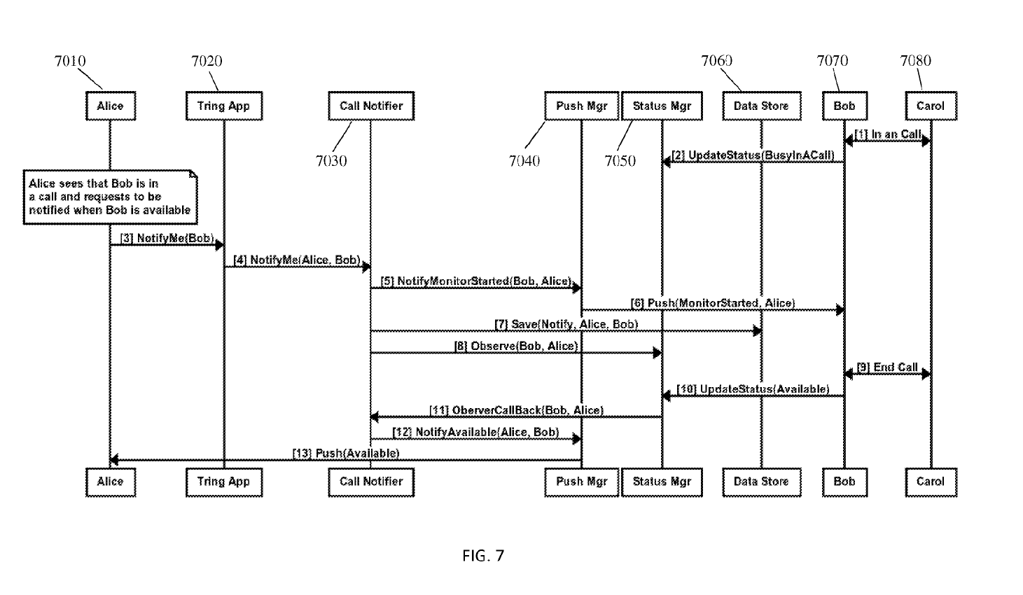

Notify a user when another user becomes available: In some cases, a registered user wishes to be notified when another registered user, which is currently not available, becomes available. Reference is made to FIG. 7, which is a flow diagram of automated issuance of notification of a change of status of a user when he/she becomes available, according to some embodiments of the present invention. Assume that user 7010 (denoted “Alice”) and user 7070 (denoted “Bob”) are registered users of a system according to some embodiments of the present invention, and user 7080 (denoted “Carol”) may be registered or not registered user of the system.. Assume that, at a certain time, users 7070 and 7080 are engaged in a call and that user 7010 concurrently places a request to be notified when user 7070 becomes available for a call. User 7010 sends the request via client application 7020 [step 3] to call notifier functionality 7030 [step 4]. The request is notified by call notifier functionality 7030 to push manager functionality 7040 [step 5] and then by push manager functionality 7040 to user 7070. The request is saved by call notifier functionality 7030 in data store functionality 7060 [step 7]. Call notifier functionality 7030 further sets an observer cycle to monitor changes in the status of the call between user 7070 and user 7080 registered with status manager functionality 7050 [step 8]. When the call between user 7070 and user 7080 ends [step 9], the change is registered with status manager functionality 7050 [step 10] and reported to call notifier functionality 7030 [step 11]. In response, call notifier 7030 issues a request to push manager functionality 7040 to get availability status of user 7070 [step 12]. Push manager functionality 7040 pushes notification of availability of user 7070 to user 7010 [step 13].

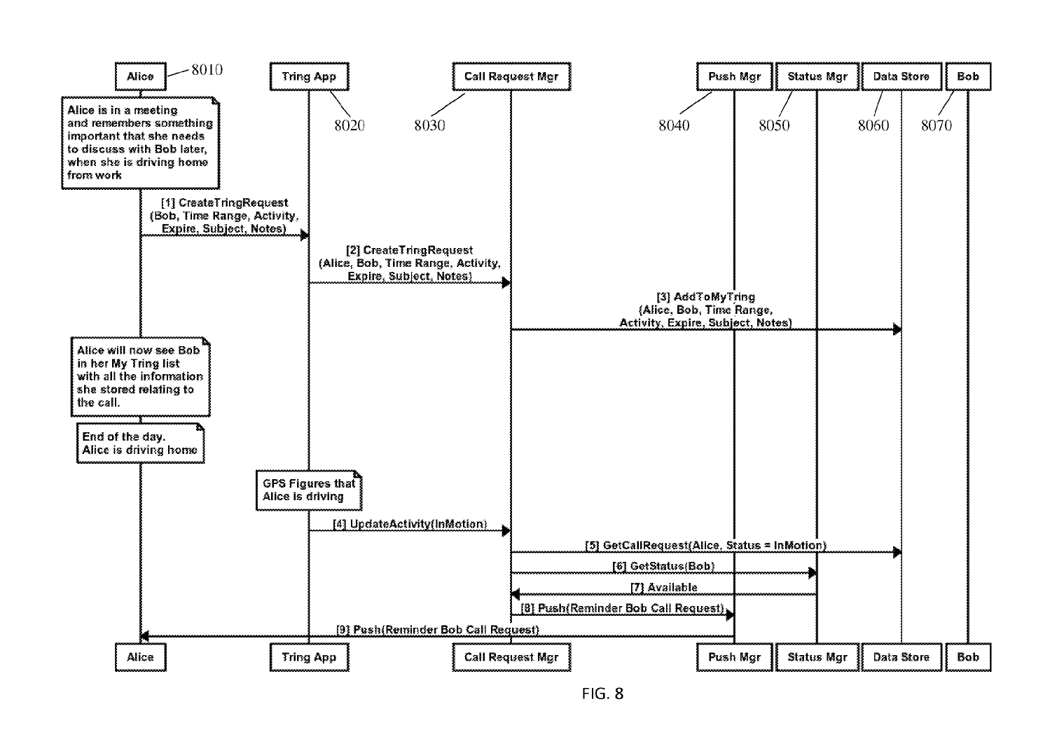

Performing a scheduled list of future calls: In some cases, a registered user of a system according to some embodiments of the present invention may wish to schedule future call/calls, for example when he/she plans to be commuting on the road. The call(s) may be initiated according to predefined time line, according to predefined geographic location or type of activity of the requesting user. For example, location may be detected using internal GPS functionality, cellular triangulation, location data extracted from appointment manager, etc. Activity type may he detected by time derivative of location changes (riding, jogging, etc.) or by extracting information from appointment manager or by indications received from a wearable device via its respective application executable by the user's phone device. Such list of future calls may be prepared and stored by the user with a system operating according to some embodiments of the present invention, as is explained herein below. Reference is made now to FIG. 8, which is a flow diagram of automated call initiation based on predefined conditions, according to some embodiments of the present invention. Assume that user 8010 (denoted “Alice”) wishes to automatically initiate a call with user 8070 (denoted “Bob”) when user 8010 is driving home after working hours. The details of the request, optionally including commentary details (subject of call, etc.) are defined by user 8010 via client application 8020 [step 1] causing creation of future call record by call request manager functionality 8030 [step 2] and registered with data store functionality 8060 [step 3]. When user 8010 is driving home, this activity may be detected [step 4], for example based on indications from a global positioning system (GPS) associated with system 1000 (FIG. 1) and may initiate, according to the predefined call list, a call from user 8010 to user 8070, as follows. Call request manger functionality 8030 updates data store functionality 8060 with the change of condition [step 5] and initiates status interrogation of user 8070 [step 6]. When the status of user 8070 is reported available to call request manger 8060 [step 7], a push reminder is sent by call request manger 8060 to push manager functionality 8040 [step 8], and push manager functionality 8040 sends a reminder of the requested call to user 8010 [step 9]. According to some embodiments, a user may set a request for future notification/reminder to perform a call to a selected callee. The notification may be set according to the user's calendar, meeting scheduler or any other relevant application executable on the user's phone device. The notification/reminder may be presented to the user when the time/event turned “true” and other conditions, such as “user is not busy”, “callee is available” (in case the callee is a registered user), and the like, are met.

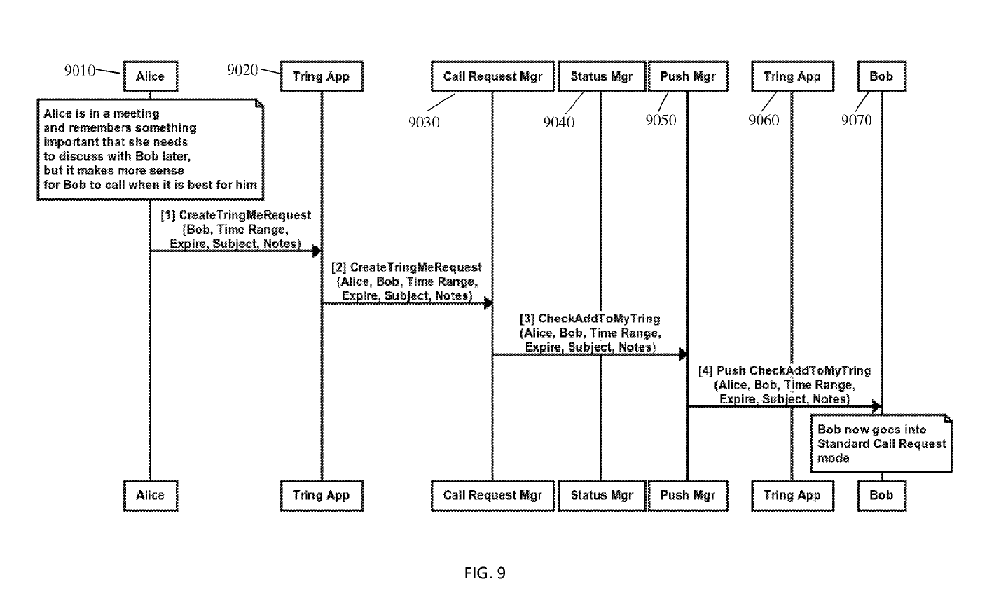

Requesting a remote user to initiate a call: in some cases a registered user may wish to ask another registered user to call him/her when certain conditions are met. Reference is made now to FIG. 9, which is a flow diagram of issuance of a request from a remote user to call when predefined conditions are met, according to some embodiments of the present invention. User 9010 (denoted “Alice”) defines a request that user 9070 (denoted “Bob”) will call him/her when certain conditions are met [step 1] via client application 9020 of user 9010. The request is registered with call request manager functionality 9030 [step 2] and with push manager functionality 9050 [step 3]. Push manager functionality 9050 checks continuously the availability and fulfillment of the predefined conditions of user 9070 [step 4] and when the conditions are met user 9070 may initiate the requested call to user 9010.

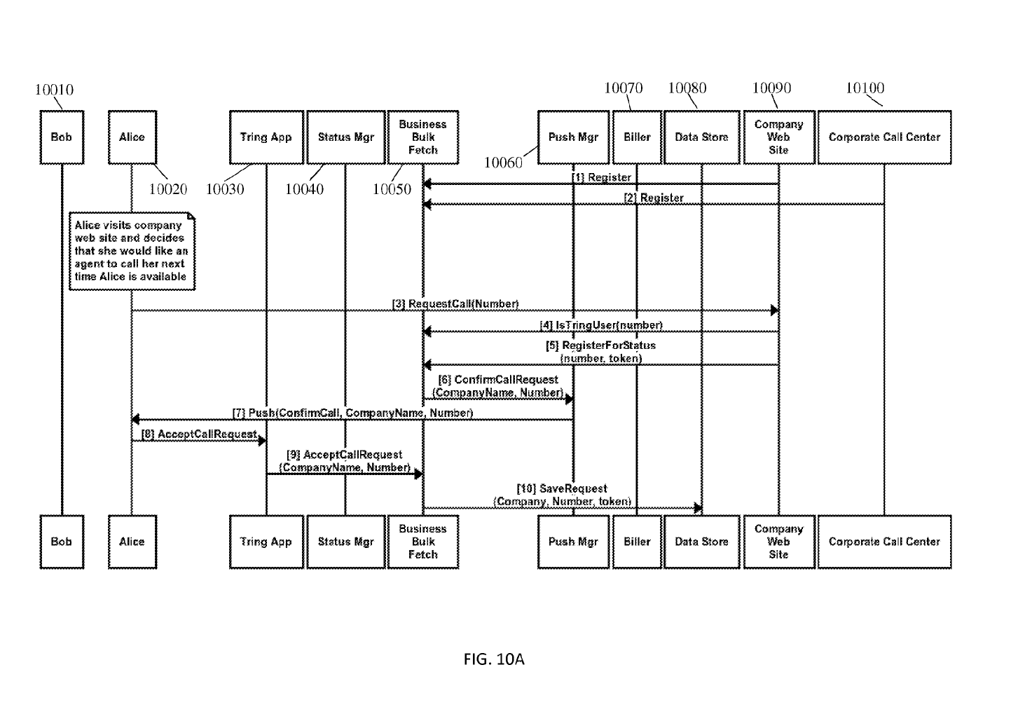

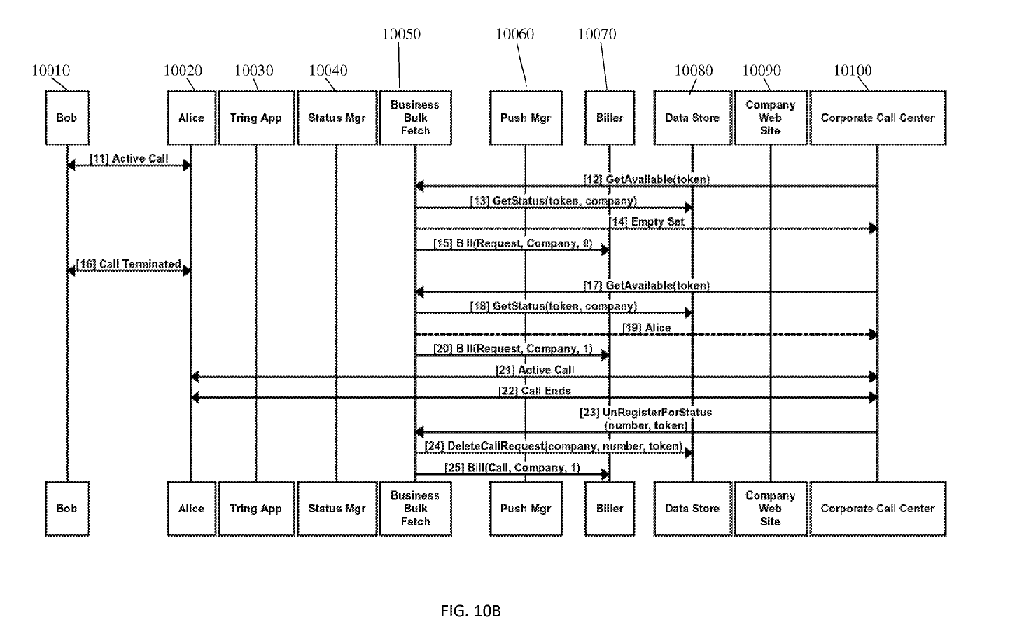

In some cases, a registered user may wish to be called by an agent of a company/service available through a web site. Such web site of the company or service may support functionalities of a system according to some embodiments of the present invention for example by installing a web application program interface (API) of the centralized service that may be integrated into the web site or the outgoing call center. Reference is made now to FIGS. 10A and 10B, which are flow diagrams of issuance of a request from a user to be called by an agent of a company or a call center service, according to some embodiments of the present invention. Assume that a web site of a company 10090 and/or a corporate call center 10100 is registered to a centralized system according to some embodiments of the present invention via business bulk fetcher functionality 10050 steps 1. 2 respectively], thereby becoming known to remote users of the system. Registered user 10020 (denoted “Alice”) places a request with, for example, company website 10090 asking to be called back by an agent of the company to a defined phone number [step 3]. Company web site 10090 interrogates hulk fetcher functionality 10050 whether user 10020 is a registered user [step 4], and, if it is not, sends a link for registering user 10020 with the system [step 5]. At this step, a token may be used in order to enable the call center application to store call center specific information regarding the specific call and to differentiate between two or more separate calls to the same number. A confirmation interrogation is sent by business bulk fetcher functionality 10050 [step 6] via push manager functionality 10060 [step 7] to user 10020 in order to verify correctness of the phone number. If correctness is confirmed by user 10020 [step 8], client application 10030 of user 10020 sends the confirmation to business bulk fetcher functionality 10050 [step 9], and the conformation is registered with data store functionality [step 10]. Assume that, at a certain time later, user 10020 and user 10010 (denoted “Bob”) are engaged in a call, thereby yielding the status of user 10020 unavailable. At that time, corporate call center 10100, where the request made by user 10020 to be called was registered, interrogates all registered users that placed requests to be called. When the availability status of user 10020 [step 12] is verified, an “unavailable” status is returned by business bulk fetcher functionality 10050 to data store functionality 10080 [step 13], and corporate call center 10100 is updated that no call was made with user 10020 [step 14]. Data indicative of client billing that relates to the number of requests made by each company and the number of available users returned may be delivered to Biller functionality unit 10070 [step 15]. Corporate call center 10100 continuously looks for calls that were registered with it and were not yet performed. After the call between user 10010 and user 10020 terminates [step 16], the availability status of user 10020 changes, and this change is detected by corporate call center 10100 [step 17] and reported to business bulk fetcher functionality 10050. Since availability of user 10020 is reported to a call by corporate call center 10100 [step 19], a call between an agent of corporate call center 10100 and user 10020 is established [step 21], and, when it ends [step 22], the call request record of user 10020 is deleted, since the job has been completed successfully. Updated billing data may be delivered to Biller functionality unit 10070 reflecting progress of carrying out call center calls [steps 20, 25].

In order to enable a user to maintain a certain level of privacy within the system, the user's client application may enable the user to configure how his/her presence/availability status will be published in the system and to whom. According to some embodiments, all presence statuses are published and every registered user can see the other user's availability status. When the user chooses to enable privacy settings, he/she may be able to restrict which status indications will be published and to control whom of the other registered users will be allowed to view these status indications. Different presence policies may be defined to enable setting of groups of users having each different approved exposure to the user's availability status indications.

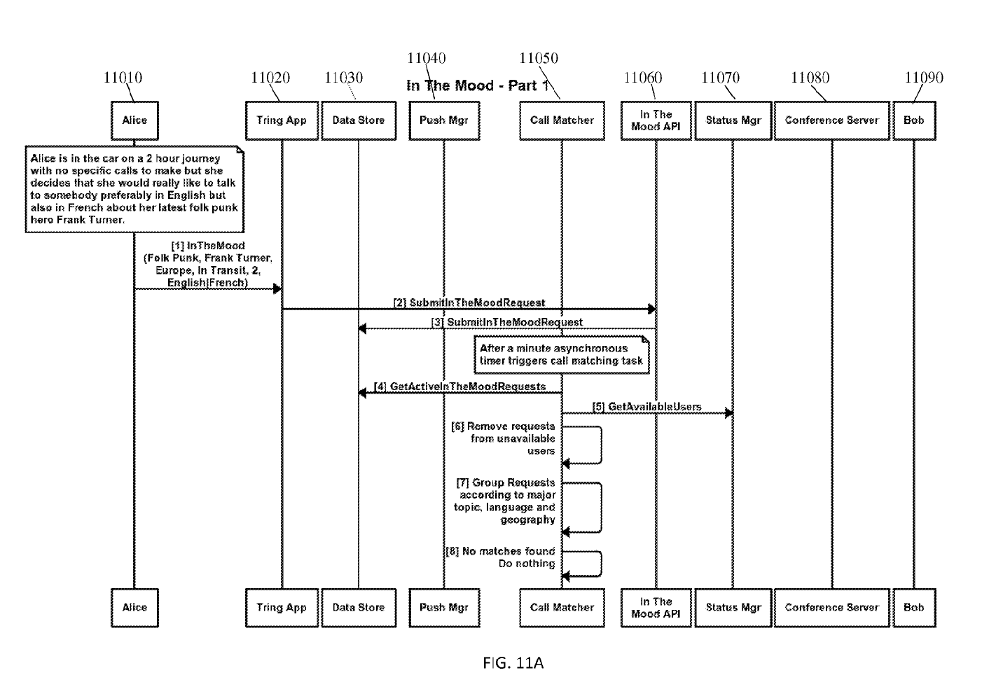

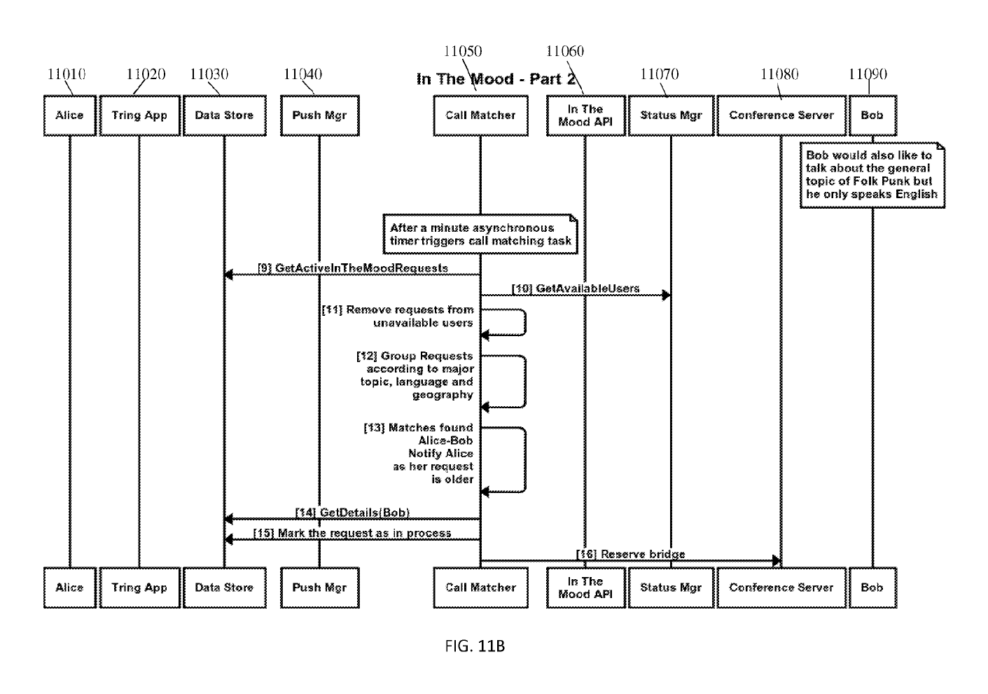

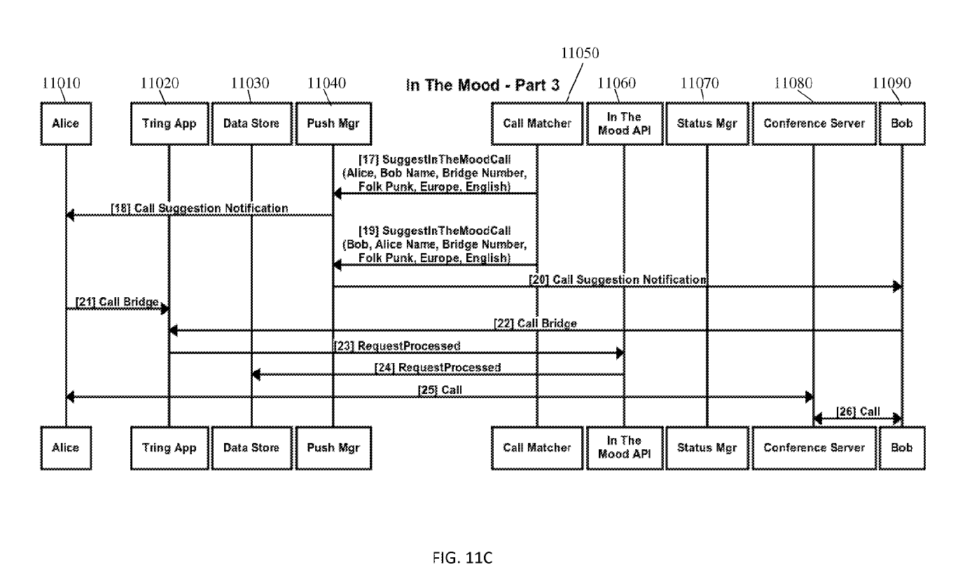

Establishing a call between parties based on common feature: A first registered user may wish to make a call with another registered user simply based on a common feature, such as common conversation subject (theater, football, etc.), on common dial area) same dial zone, same national zone, etc.), and the like. The first registered user does not know who will be the second user, nor does he/she know the dial number of that user. Reference is made to FIGS. 11A, 11B and 11C which are flow diagrams of automated call establishment between two parties based on common feature defined by the parties, according to some embodiments of the present invention. First user 11010 (also denoted “Alice”) defines its preferences for automated call establishment [step 1] via its respective client application 11020, and the relevant data is delivered to In The Mood functionality unit 11060 and saved there [step 2]. The request of user 11010 is delivered to data store functionality 11030 and saved for later use [step 3]. The system triggers, by call matcher functionality 11050, a job for looking for another user having matching call preferences in data store functionality 11030 [step 4]. A request for availability status is issued to status manager functionality 11070 by call manager functionality 11050 [step 5]. Unavailable users are ignored [step 6]. Available users are explored based on the conversation topics defined by first user 11010 [step 7], and if no match is found no action is taken [step 8]. The process of looking for available user(s) the requested conversation topics of which match those of first user 11010 may automatically be repeated steps 11. 12]. and if match is found, for example, with second user 11090 (also denoted “Bob”), a “match” notice is sent to first user 10010 [step 13]. The call details of second user 11090 are fetched by call matcher functionality 11050 from data store functionality 11030 [step 14], and the request of first user 11010 is marked “in process” [step 15]. In order to automatically establish a call between first user 11010 and second user 11090 without providing any one of them with the dialing details of the other, a conference bridge may be kept by the system without providing same to the other party [step 16], and first user 11010 is provided by call manager functionality 11050 with the name and topics of second user 11090 and the conference details [step 18] via push manager functionality [step 17]. Subject to acceptance of the call suggestion by first user 11010, the name and topics of first user 11010 are suggested to second user 11090 [step 20] by call manager functionality 11050 via push manager functionality [step 19]. Subject to acceptance of the suggested call from first user 11010 by second user 11090 a conference call may automatically be established by conference server functionality 11080 [steps 20-25], enabling first user 11010 and second user 11090 to hold a telephone conversation that was automatically established based merely on a match between the conversation topics/identifiers/features defined by each of them, without needing to know the number of each other.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for automatically notifying a user of meeting conditions for establishing a call between two parties based on the parties availability, comprising:
providing availability status of a first party and of a second party to a central service;
monitoring, by said central service, a request by said first party to establish a phone call with said second party;
continuously monitoring the availability status of said second party to identify when said second party becomes available for a phone call; and
automatically notifying a user of meeting conditions for establishing a phone call between said first party and said second party.

2. The method of claim 1 further comprising:
when said second party becomes available notifying a user of meeting conditions for establishing a phone call with said first party only if a predefined call condition of said first party and said second party are met.

3. The method of claim 2 wherein said predefined call condition of said first party is at least one from the list comprising time in the day, geographic location, type of activity of said first party.

4. The method of 1 wherein a request to establish a call is first made by said second party.

5. The method of claim 4 wherein the establishing of said call is made only after at least one predefined status condition of said first party is met.

6. The method of claim 5 wherein said predefined status condition of said first party is at least one from a list comprising time in the day, geographic location, type of activity of said first party.

7. The method of claim 1 wherein said second party is an automated call center.

8. The method of claim 7 wherein said automated call center is adapted to call said first party if said first party left a message with said automated call center and said first party is automatically detected as available to receive a call from said automated call center.

9. The method of claim 8 wherein in case said automated call by said call center fails a repeated call is automatically initiated within a predefined period of time.

10. A system for enabling automated establishment of calls between parties based on the parties availability and the parties request to establish a call, the system comprising:
a client application program associated with said system operable by each party of said system;
a call request manager functionality operable by a central service of said system, to receive call requests from at least one of said parties;
a status manager functionality operable by a central service of said system to monitor and reflect availability status of said parties;
a push manager functionality operable by a central service of said system to initiate a call establishment process between two of said parties when one of the parties becomes available to take a call.
